(19) United States
(12) Patent Application Publication
(10) Pub. No.: US 2013/0269728 A1
(43) Pub. Date: Oct. 17, 2013

(54) Methods For Cleaning Articles Using N-propyl Bromide Based Solvent Compositions

(71) Applicants: Keiji Ando, Yokohama-shi (JP); Hisashi Miwa, Setagaya-ku (JP)

(72) Inventors: Keiji Ando, Yokohama-shi (JP); Hisashi Miwa, Setagaya-ku (JP)

(73) Assignee: Albemarle Corporation, Baton Rouge, LA (US)

(21) Appl. No.: 13/994,846

(22) PCT Filed: Dec. 12, 2011
(86) PCT No.: PCT/US11/64349

§ 371 Date: Jun. 17, 2013

Related U.S. Application Data
(60) Provisional application No. 61/424,123, filed on Dec. 17, 2010.

(51) Int. Cl. C11D 7/50; B08B 3/14

(52) U.S. Cl. CPC C11D 7/5022; B08B 3/14; C11D 7/5018
USPC 134/6; 134/10; 510/505; 510/273; 510/109

(57) ABSTRACT

Methods for cleaning articles using n-propyl bromide-based solvent compositions are provided. According to one method, an article to be cleaned is contacted with a solvent composition comprising about 50 weight percent to about 99 weight percent n-propyl bromide and about 0.5 weight percent to about 50 weight percent of an alcohol. Such methods remove at least one of water or water soluble contaminants. Such methods are useful as a degreaser and/or cleaner in both cold cleaning and hot rinsing systems for cleaning articles.

### FIELD OF THE INVENTION

The present invention generally relates to the field of cleaning articles using n-propyl bromide-based solvent compositions.

### BACKGROUND

n-Propyl bromide (also referred to as propyl bromide, 1-bromopropane or NPB) is recognized as an environment friendly commercial product. Use of n-propyl bromide-based cleaning solvent compositions in the removal of residues from precision metal products and electronic articles or parts is well known in the art. Typical solvent cleaning methods include cold cleaning and vapor degreasing.

In a typical cold cleaning or vapor degreasing process, an article to be cleaned is placed in contact with a solvent or its vapor, in a sump, such that the solvent dissolves away the contaminating residues. The cold cleaning or vapor degreasing apparatus may optionally have ultrasonic generator(s) in order to facilitate better cleaning.

Various known compositions and methods for cleaning articles using n-propyl bromide-based solvent systems use stabilizers along with the n-propyl bromide. Examples of stabilizers include amines, epoxides, ethers and nitroalkanes. A method for cleaning articles using a solvent system comprising n-propyl bromide and a surfactant is also known. These and other methods, however, are not suitable for removing water or water-soluble contaminants.

Water has a very low solubility in n-propyl bromide. Therefore, when cleaning articles having water and/or water-soluble surface contaminants, typically an n-propyl bromide-based solvent is mixed with water by agitation in an attempt to remove such surface contaminants. However, the NPB and water mixture easily forms an emulsion that is difficult to separate. Decomposition of n-propyl bromide is another concern with existing n-propyl bromide-based solvent systems. n-Propyl bromide reacts with water easily and if there is an excess of water in an n-propyl bromide based solvent, the n-propyl bromide decomposes at more than six times its normal decomposition rate. Further, the waste treatment for an emulsion of n-propyl bromide, water, and surfactants requires much energy, and is equipment intensive.

Thus, there is a need for methods to remove water and/or water-soluble contaminants using an n-propyl bromide-based solvent, which does not form an emulsion with the water and/or water-soluble contaminants, and which eliminates the problems of separability, and decomposition discussed earlier.

### SUMMARY OF THE INVENTION

This invention provides such methods comprising contacting an article with a solvent composition comprising n-propyl bromide ranging from about 50 weight percent to about 99 weight percent and an alcohol ranging from about 0.5 weight percent to about 50 weight percent for removing at least one of water or water soluble contaminants.

This invention also provides such methods comprising introducing the combination of the solvent, and the water or water-soluble contaminants to a tank for separation and returning the separated solvent to a sump. Methods of the present invention further comprise a step wherein the solvent is regenerated. Non-limiting examples of methods used for solvent regeneration are separation or filtration. For example, the solvent is regenerated using membrane filtration or gravity separation.

Further features and advantages of the present invention are described in detail below with reference to the accompanying examples.

### DETAILED DESCRIPTION

The present invention provides methods for cleaning an article using an n-propyl bromide-based solvent composition. The solvent composition comprises about 50 weight percent to about 99 weight percent n-propyl bromide and about 0.5 weight percent to about 50 weight percent alcohol. The cleaning methods of this invention are useful in the removal of at least one of water or water-soluble contaminants from the article.

As used herein, the term “cleaning” means cold cleaning and/or hot rinsing; the term “cold cleaning” means rinsing with a solvent at ambient temperature; and the term “hot rinsing” means rinsing with condensed solvent. Herein, the terms “solvent” and “solvent composition” are used interchangeably.

The concentration of n-propyl bromide in solvents of the present invention can be from about 50 weight percent to about 99 weight percent, or from about 70 weight percent to about 98 weight percent.

The alcohol co-solvent for the composition can be an aliphatic monohydric alcohol. The alcohol can be selected from 1-propanol, isopropyl alcohol, 1-butanol, 2-butanol, isobutyl alcohol, tertiary butyl alcohol, 1-heptanol, 1-hexanol and pentanol, including mixtures thereof. In one aspect of the invention, the alcohol is selected from the group consisting of 1-propanol, 1-butanol, 2-butanol, isobutyl alcohol and pentanol, including mixtures thereof.

The concentration of the alcohol in solvents of the present invention can be about 0.5 weight percent to about 50 weight percent, or about 1 weight percent to about 40 weight percent, or about 2 weight percent to about 30 weight percent.

The methods presented herein may be used for cleaning a variety of articles. Non-limiting examples of articles include metal products, glass products, plastics, polymeric substrates, electronic components or articles, and combinations thereof.

In one aspect of this invention, the cleaning is achieved by contacting the article in a sump containing the solvent composition. The article is optionally subjected to ultrasonic agitation, or is contacted with a jet stream of the solvent composition. In another aspect, the solvent composition is sprayed on the article prior to cleaning. In yet another aspect, the cleaning is done by wiping the article with the solvent composition.

Methods of the present invention are suitable, e.g., for use in cold cleaning applications for removing at least one of water or water soluble contaminants from the article. The cold cleaning of articles is typically performed at ambient temperature, e.g., up to about 55 degrees C. Cold cleaning is usually characterized by the immersion and soaking of the article to be cleaned in the solvent composition with or without agitation. Articles which are too large to be immersed may be sprayed or wiped with the solvent composition. Ultrasonics may be used in conjunction with the cold cleaning for removing at least one of water or water-soluble contaminants from deep recesses or other inaccessible areas. Methods of the present invention are also suitable for use in hot rinsing applications for removal of at least one of water or water-soluble contaminants from the article. This can be achieved by using a vapor immersion unit which usually has two solvent-filled sumps. In one sump the solvent composition is boiled at the boiling point of the solvent composition, while in the other sump clean, distilled condensate solvent is provided, and is used for rinsing. As is familiar to those skilled in the art, the boiling point is determined by the combination of nPB and selected alcohols and their ratios in the solvent composition. The hot rinsing application may optionally be provided with ultrasonics for removing at least one of water or water-soluble contaminants from deep recesses or other inaccessible areas.

In another aspect, hot rinsing involves a vapor/spray unit in which the solvent composition is boiled in a one-sump rinser. A perforated metal stand is provided just above the boiling solvent in order to hold the article to be cleaned. The rinser may optionally be provided with a manual spray wand for removing at least one of water or water-soluble contaminants from deep recesses or other in accessible areas.

In yet another aspect, the hot rinsing application rinser is provided with a set of cooling coils near its top. The cooling coils contact the solvent vapor before it escapes from the unit, which causes cooling and condensation of the vapor. The vapor condensate flows back to a clean tank wherein the solvent composition and at least one of water or water-soluble contaminants are separated using various separation methods including without limiting to, membrane separation and/or gravity separation.

Methods of the present invention offers several advantages over existing methods for the same applications and these will be described in greater detail by way of specific examples. The following examples are offered for illustrative purposes, and are not intended to limit the invention in any manner.

One of the advantages of the present invention is that the solvent compositions used in the methods of the present invention does not form emulsions even in presence of excess of water, which results in methods of this invention providing removal of at least one of water or water-soluble contaminants, and at the same time gives good separation between water phase and solvent phase.

Yet another advantage is that solvent compositions of the present invention can easily and rapidly remove water or water-soluble contaminants from articles without undergoing rapid decomposition in presence of water.

### EXAMPLES

The following examples are illustrative of the principles of this invention. It is understood that this invention is not limited to any one specific embodiment exemplified herein, whether in the examples or the remainder of this patent application.

### Example 1

Experiments were conducted, at room temperature, in order to assess the rinseability of solvent compositions used in methods of the present invention. In these experiments, 15 ml of freshly prepared glass beads, having a diameter of 2 mm, were put into a 25 ml measuring cylinder, and 2 ml water was added on the glass beads in the 25 ml measuring cylinder. 10 ml of the solvent comprising 90 weight percent of n-propyl bromide and 10 weight percent of alcohols was then added to the measuring cylinder containing glass beads and water. The volume of the water phase was measured after 5 minutes. A water phase volume of 0.5 ml or more was considered as a positive test for rinseability, with increasing volumes indicating better rinseability. The results are summarized in Table 1.

### Example 2

As in Example 1, experiments were conducted, at room temperature, in order to evaluate the separability of solvent compositions used in methods of the present invention. In these experiments, 10 ml of the solvent comprising 90 weight percent of formulated n-propyl bromide and 10 weight percent of alcohols was poured into a 100 ml glass bottle. 2 ml of water was added to the solvent; then the bottle was capped, and shaken in order to mix the solvent and water. Absence of emulsion was considered as a positive test for separability. The results of this test are also summarized in Table 1.

TABLE 1

| | Composition | | | | |
|---|---|---|---|---|---|
| | n-Propyl | | | | |
| | bromide | Alcohol | | Rinse- | |
| | (weight | | Weight | ability | Separability |
| | percent) | Name | percent | (Ex. 1) | (Ex. 2) |
| 1 | 90 | 1-propanol | 10 | 1.6 | Pass |
| 2 | 90 | 1-butanol | 10 | 1.2 | Pass |
| 3 | 90 | 1-pentanol | 10 | 1.4 | Pass |
| 4 | 90 | 1-hexanol | 10 | 1.0 | Pass |
| 5 | 90 | 1-heptanol | 10 | 1.0 | Pass |

### Example 3

The decomposition rate of n-propyl bromide was measured by determining the consumption rate of 1,2-butylene oxide. 0.5g of 1,2-butylene oxide was added to 95 g of pure n-propyl bromide in order to achieve a final concentration of 0.5 weight percent, and poured in equal volumes into two 100 ml sample bottles. 2 g and 0.1 g water was poured into each sample bottle. The sample was kept at 50 degrees Centigrade for 100 hrs. An aliquot was taken from the sample bottle and analyzed for consumption of 1,2-butylene oxide by means of a gas chromatograph. The results are presented in Table 2.

TABLE 2

| | Water content | Consumption rate of 1,2- |
|---|---|---|
| Temperature | (wt %) | butylene oxide (ppm/hr) |
| 50 sup. | 0.1 | 3 |
| degrees. | 2 | 20 |
| Centigrade | | |

It is to be understood that the above description is intended to be illustrative and not restrictive. Many embodiments may be apparent to those of skill in the art upon reading the above description. The scope of the invention should, therefore, be determined not with reference to the foregoing description, but should instead be determined with reference to the appended claims, along with the full scope of equivalents to which such claims are entitled. The disclosures of all articles and references, including patent applications and publications, are incorporated herein by reference for all purposes.

What is claimed is:

1. A method of cleaning an article, the method comprises contacting the article with a solvent composition comprising n-propyl bromide ranging from about 50 weight percent to about 99 weight percent and an alcohol ranging from about 0.5 weight percent to about 50 weight percent for removing at least one of water or water soluble contaminants.

2. The method of claim 1 wherein the concentration of n-propyl bromide ranges from about 70 weight percent to about 98 weight percent.

3. The method of claim 1 wherein the alcohol is an aliphatic monohydric alcohol.

4. The method of claim 1 wherein the alcohol is selected from a group consisting of 1-propanol, isopropyl alcohol, 1-butanol, 2-butanol, isobutyl alcohol, tertiary butyl alcohol, 1-heptanol, 1-hexanol and pentanol, including mixtures thereof.

5. The method of claim 1 wherein the concentration of the said alcohol ranges from about 2 weight percent to about 30 weight percent.

6. The method of claim 1 wherein the article is selected from a group consisting of metal products, glass products, plastics, polymeric substrates, electronic components or articles, and combinations thereof.

7. The method of cleaning of claim 1 which is selected from vapor degreasing, cold cleaning, hand wipes, aerosols and sprays.

8. The method of claim 1 wherein the article is contacted with the said solvent by dipping in a sump filled with the said solvent, or by wiping it with the said solvent or by spraying the said solvent on the article.

9. A method of removing at least one of water or water-soluble contaminants from an article, the method comprising:
a) Contacting the article in a sump filled with a solvent comprising:
i. n-propyl bromide, in the range of about 50 weight percent to about 99 weight percent; and
ii. Alcohol, in the range of about 0.5 weight percent to about 50 weight percent;
b) Introducing the mixture consisting of the said solvent, and water or water-soluble contaminants to a tank for separation.
c) Returning the separated solvent to the sump.

10. The method of claim 9 wherein said separation is done by using equipment selected from the group consisting of membrane separator and gravity separator, including combinations thereof.

11. The method of claim 9 wherein the concentration of n-propyl bromide ranges from about 70 weight percent to about 98 weight percent.

12. The method of claim 9 wherein the alcohol is an aliphatic monohydric alcohol.

13. The method of claim 9 wherein the alcohol is selected from a group consisting of 1-propanol, isopropyl alcohol, 1-butanol, 2-butanol, isobutyl alcohol, tertiary butyl alcohol, 1-heptanol, 1-hexanol and pentanol, including mixtures thereof.

14. The method of claim 9 wherein the concentration of the said alcohol ranges from about 2 weight percent to about 30 weight percent.

15. The method of claim 9 wherein the article is selected from a group consisting of metal products, glass products, plastics, polymeric substrates, electronic components or articles, and combinations thereof.
